(19) United States
(12) Patent Application Publication
(10) Pub. No.: US 2014/0093684 A1
(43) Pub. Date: Apr. 3, 2014

(54) ULTRA CLEAR SCRATCH RESISTANT COATING AND LAMINATE

(71) Applicant: Ashland Licensing and Intellectual Property LLC, Dublin, OH (US)

(72) Inventors: Dennis Jay Oscar, West Bend, WI (US); Charles J. Wasserman, Waukesha, WI (US); Daniel P. Noffke, Oak Creek, WI (US)

(73) Assignee: Ashland Licensing and Intellectual Property LLC, Dublin, OH (US)

(21) Appl. No.: 14/034,989

(22) Filed: Sep. 24, 2013

Related U.S. Application Data
(60) Provisional application No. 61/708,315, filed on Oct. 1, 2012.

(51) Int. Cl. C09D 7/12

(52) U.S. Cl. CPC C09D 7/1233
USPC 428/143; 428/195.1; 428/211.1; 428/203; 428/423.1; 524/100

(57) ABSTRACT

An ultra-clear rub and scratch resistant aqueous based coating that provides barrier properties to film and is receptive to flexo, litho, and gravure printing inks includes polyurethane acrylic hybrid dispersion in combination with melamine formaldehyde resin and micronized wax. The coating composition can be formulated with little or no N-methylpyrrolidone. This coating can be applied to a wide variety of different polymers such as polyesters, metalized polyesters, polyamides, metalized polyamides, biaxially oriented polypropylene, and others.

### BACKGROUND OF THE INVENTION

Hi-gloss paperboard stock is generally formed by laminating a polymer film such as polyester, polyamide, or metalized polymer to a paper board substrate. In order to print on these laminates a primer or coating composition must be applied. Such coating compositions should be substantially more than 90% clear, and provide barrier properties to prevent processing aids in the polymer from interfering with adhesion of ink onto the surface.

These also should provide scratch and rub protection for the polymeric surface. There are a number of such primers currently employed. For example, an aqueous blend or dispersion of polyurethane and acrylic polymers such as methylmethacrylate have been employed. These require a substantial amount of N-methylpyrrolidone (NMP) which requires a long of time to evaporate. This coating creates a slight haze which prevents maximum clarity. When applied on a white plastic surface, they can cause a haze. Styrene acrylic aqueous dispersions have also been employed. However, these do not work on biaxially oriented polypropylene and require cross linkers such as aziridine crosslinkers. Their clarity is also unsatisfactory.

### SUMMARY OF THE INVENTION

The present invention is premised on the realization that a water-based primer for shiny polymeric substrates can be formed from a polyurethane polymer copolymerized to vinyl monomers such as acrylic monomers in combination with melamine formaldehyde and micronized wax. This combination provides excellent clarity, is useful for polyesters, polyamides, metalized polyesters and polyamides, as well as biaxially oriented polypropylene. These provide excellent dry film surface tension and have clarities close to 99 percent, significantly better than competitive products. Further, these do not require high concentrations of NMP, which allows the composition to be applied and dried more quickly, reducing the cost. Further, because of the low concentration of solvent, a thinner film can be applied. Finally, the micronized wax particles have a particle thickness that is greater than the applied thickness of the polymeric solids and, thus, protrude beyond the polymeric solid film providing scratch and rub resistance.

The objects and advantages of the present invention will be further appreciated in light of the following detailed description.

### DETAILED DESCRIPTION

A coating composition or primer for use on a polymeric substrate includes an aqueous dispersion of a polyurethane vinyl monomer copolymer, water dispersible melamine formaldehyde resin, micronized wax, and a water miscible solvent. The aqueous polyurethane vinyl polymer dispersions are reaction products formed by adding a vinyl monomer composition having ethylenically unsaturation to a water dispersible isocyanate terminated polyurethane pre-polymer. These can be reacted with, for example, a free radical initiator, forming what is referred to as a polyurethane vinyl monomer hybrid. Typically, such products are polyurethane acrylic hybrids, which are water dispersible and include the polymer dispersed in a water miscible solvent such as N-methylpyrrolidone or dipropylene glycol-dimethylether (DMM).

Such polymers are disclosed, for example, in U.S. Pat. No. 5,173,526, the disclosure of which is hereby incorporated by reference. Commercially available products are sold by Air Products and Chemicals, Inc., under the name of Hybridur. One particular product particularly useful for the present invention is Hybridur 580. This is a 39.5 to 40.6 solids product with 3 to 7% NMP and greater than 50% water. Other urethane acrylic hybrids can be obtained from Essential Industries of Murten, Wis. On a solids basis the coating composition can broadly have 32 to 42% hybrid polymer.

These formulations generally contain about 5 to about 10% water miscible solvent which helps maintain the polymer dispersed in water. The Hybridur product has approximately 5.7 percent solvent, and specifically N-methylpyrrolidone. This can be replaced with DMM making the composition substantially free of N-methylpyrrolidone. “Substantially free” indicates less than 1% and preferably less than a half a percent NMP, and most preferably no detectable NMP.

In addition, the composition will include a water dispersible melamine formaldehyde resin in an amount from about 1 to about 5%, generally 2 to 3% with a target of about 2.5%. The melamine formaldehyde resin provides a smooth continuous coating. It also acts as a crosslinker and improves clarity. Commercially available melamine formaldehyde resins include Cymel 350 and Cymel 303, which are 97 to 98% solids.

The coating composition will further include micronized wax, in particular micronized wax particles. The particle size of the micronized wax should be greater than the thickness of the applied polymeric coating. In other words, the polyurethane acrylic hybrid/melamine formaldehyde portion of the coating, once applied and dried, should be thinner than the diameter of the micronized wax particles so that the wax particles protrude above the coating, acting to inhibit scratching of the surface.

Generally, the micronized wax particles will have a size of about 5 to about 15 microns. In particular, a particle size of about 10 to 12, and in particular 11 microns, is particularly suitable for these particular applications.

The coating composition will further include a water miscible organic coupling solvent. Particular solvents that are suitable for use in the present invention will include glycol ethers, in a particular, for example, propylene glycol ethers such as Dowanol PM. The solvent is present in an amount effective to lower the wet film surface tension of the coating. This improves coverage. These solvents also act as antifoaming agents. Generally this will be from about 1.5 to about 3 percent, and generally from 2 to about 2.5 percent.

The formulations can also include a multifunctional amine to adjust pH and as a crosslinker for the melamine formaldehyde. The formulation can include other functional components typically used in these formulations, such as antifoaming agents. The remainder of the formulation will be deionized water. Generally, the solids content or, conversely, the amount of water present determines the viscosity of the coating. Although the desired viscosity will vary depending upon the particular coating equipment, generally the viscosity should be from about 25 to about 200 cP. (Brookfield RVF #2 at 20 RPM, 76° F.±1). These viscosities are observed with coatings having a solids content of 30 to 45%. Generally the viscosity will be 35 to 70 cP, which corresponds to a solids content of 34.5 to 35.5%.

The product is formed by simply blending the components, and the order of mixing is not necessarily critical. However, the micronized wax particles can first be mixed with the melamine formaldehyde resin dispersion, adding the wax slowly to prevent lumps and ensure that it is well dispersed. The polyurethane acrylic hybrid can then be blended with the solvent, and then these are combined slowly with the wax melamine formaldehyde blend. Sufficient deionized water is added to achieve the desired viscosity, and the product is thoroughly mixed. This can be filtered, if desired.

The composition can be used to coat a variety of different substrates. For example, the base substrate may be polyamide, such as nylon, polyester, such as PET, polypropylene, polyethylene, polyvinyl chloride (PVC), metalized PET, metalized nylon and biaxially oriented polypropylene, as well as others. The base substrate may have a thickness of about 0.02 mil to about 25 mil, although other thicknesses are within the scope of the invention. Examples of base substrates that may be used include CAPRAN® POLYAMIDE AVAILABLE FROM Honeywell, Morris Township, N.J., U.S.A., LUMIRROR polyester available from Toray Plastics (America) Inc., Fort Royal, Va., U.S.A., MYLAR® and MELINEX® polyester available from DuPONT TEIJIN FILMS™, Hopewell, Va., U.S.A., BICOR® and SYNCARTA® polypropylene available from ExxonMobil Chemical, Baytown, Tex., U.S.A. and CRX and AQS polypropylene available from AET Films, New Castle, Del., U.S.A.

In most applications the base substrate will be a laminate, in particular paperboard stock, coated or adhered to one of these polymeric layers.

The water based coating composition is generally applied to the base substrate using typical graphic arts application methods such as gravure, flexo, rod, slot die and the like. Application rates (i.e. coating weights) are generally less than or equal to about 3 dry pounds of water based coating composition per about 3,000 square feet of base substrate, preferably less than or equal to about 2.40 dry pounds of water based coating composition per about 3,000 square feet of base substrate and typically less than or equal to about 2.25 dry pounds of water based substrate.

Any compatible ink composition can be applied to the surface. These can be applied by flexo, litho or gravure printing presses. When the ink is applied there will be areas of the coating which are not coated with ink. These areas will act to improve adhesion with any top coat such as a varnish or outer laminated film layers.

### EXAMPLES

In the following examples various coating formulations were prepared. Examples 1 and 2 are comparative examples showing a styrene acrylic coating in Example 1 and a polyurethane dispersion acrylic dispersion blend in Example 2. Examples 3 and 4 are examples embodying the present invention. Example 3 uses N-methylpyrrolidone, whereas Example 4 uses DMM and no N-methylpyrrolidone.

TABLE 1

| Property | Example 1 | Example 2 | Example 3 | Example 4 |
|---|---|---|---|---|
| Chemistry | Styrene/Acrylic | PUD + Acrylic | Urethane/Acrylic | Urethane/ |
| | | | Hybrid | Acrylic Hybrid |
| HDPE wax emulsion | Yes | Not known | No | No |
| Micronized wax | Yes | No | Yes | Yes |
| VOC | 1-2% | 10-15% | 14-15% | 10-12% |
| NMP | 0.00% | 8.75%% | 3-7% | 0.00% |
| Aziridine Crosslinker | Yes | No | No | No |
| *Rub & scratch resistance | Best | Good | Good | Good |
| *Clarity on PET | Worst | Good | Best | Best |
| *Flow | Orange peel | 3rd Best | Best | 2nd best |
| *Dry film surface tension | 35-40 | 45-50 | 54-60 | 35-40 |
| *Barrier to processing aids | No | Yes | Yes | Yes |
| *Tape Adhesion to PET | Good | Good | Good | Good |
| Cost | Lowest | Highest | 2nd lowest | 2nd highest |

*Drawdown on PET at 0.73 to 1.61 dry grams per square meter. Dried 30 seconds at 265° F. Then aged overnight.

The composition of Example 3 included 80.98% Hybridur 580; 2.2% Dowanol PM, 2.5% Cymel 303 ULF, 0.1% Neptune 5223N4 micronized wax, 0.1500% hexamethylene tetraamine to adjust ptt, and 14.07% deionized water.

Example 4 included 90% polyurethane acrylic hybrid using DMM as a solvent as opposed to NMP, 2.2% Dowanol PM, 2.5% Cymel 350, 0.1% Neptune 5223N4, 5.2% deionized water.

Dry film surface tension was tested by applying conventional wetting tension standard solutions to drawdown samples. Adhesion for each example was determined by applying a known modified (3M) version of the ASTM D3359-08 test method for measuring adhesion by tape. ASTM D3359-08 is incorporated herein in its entirety by reference.

Scratch resistance testing was performed subjectively by using finger nails to scratch the surface of the dry film for samples of each example. Self healing was evaluated by watching the scratches and damage made in the coating during the scratch resistance tests over time and seeing if the damage appears to become less and less.

Flow and leveling were evaluated by visual inspection of the wet coating after the coating was applied and as the coating dried.

As the test data demonstrate, the coating composition of the present invention had excellent surface tension varying from 35 to 60, acted as a barrier to processing agents, showed good adhesion to PET, extremely good clarity as well as good rub and scratch resistance. Further, it had a relatively low content of NMP, making this coating composition a superior substitute for either a styrene acrylic coating or a polyurethane dispersion acrylic dispersion coating.

This has been a description of the present invention along with the preferred method of practicing the present invention. However, the invention itself should only be defined by the appended claims, WHEREIN WE CLAIM:

What is claimed is:

1. A laminate comprising a polymeric film having a first surface coated with an aqueous based coating said coating comprises polyurethane acrylic hybrid dispersion, melamine formaldehyde and micronized wax particles said wax particles having a diameter and said coating having a film thickness formed by the combination of the polyurethane acrylic hybrid and melamine formaldehyde;
said coating at least partially coated with ink.

2. The laminate claimed in claim 1 wherein said polymeric film is bonded to paperboard.

3. The laminate claimed in claim 1 wherein said coating comprises less than 10 percent N-methylpyrrolidone.

4. The laminate claimed in claim 3 wherein said coating comprises less than 6 percent N-methylpyrrolidone.

5. The laminate claimed in claim 1 wherein said coating is substantially free of N-methylpyrrolidone.

6. The laminate claimed in claim 1 wherein said coating further comprises glycol ether solvent.

7. The laminate claimed in claim 1 wherein said polymeric film is selected from the group consisting of polyester, metalized polyester, polyamide, metalized polyamide and biaxially oriented polypropylene.

8. The laminate claimed in claim 1 wherein said diameter of said wax particles is greater than said film thickness.

9. The laminate claimed in claim 1 further comprising an outer coating over said ink.

10. The laminate claimed in claim 9 wherein said outer coating comprises a varnish.

11. A coating composition comprising water, a polyurethane acrylic hybrid polymeric dispersion, melamine formaldehyde, zero to 10 percent N-methylpyrrolidone, and micronized wax.

12. The coating composition claimed in claim 11 wherein said micronized wax has an average diameter of 4 to 15 microns.

13. The coating composition claimed in claim 9 wherein said micronized wax has an average diameter of from about 10 to about 12 microns.

14. The coating composition claimed in claim 11 wherein said coating composition has a total polymeric solids content of 30 to about 45%.

15. The coating composition claimed in claim 12 further comprising a glycol ether solvent.

16. The coating composition claimed in claim 15 wherein said solvent is selected from the group consisting of propylene glycol dimethylether and dipropylene glycol dimethylether.

17. The composition claimed in claim 12 further comprising a multifunctional amine.

18. The coating composition claimed in claim 11 comprising 32 to 42% polyurethane acrylic hybrid on a solids basis.

19. A method of improving ink adhesion to a polymeric film comprising coating said polymeric film with the coating composition of claim 11.
